(19) United States
(12) Patent Application Publication
(10) Pub. No.: US 2022/0131453 A1
(43) Pub. Date: Apr. 28, 2022

(54) MOTOR AND METHOD OF MANUFACTURING FIELD SYSTEM

(71) Applicant: SEIKO EPSON CORPORATION, Tokyo (JP)

(72) Inventor: Shigekazu TAKAGI, SHIOJIRI-SHI (JP)

(21) Appl. No.: 17/511,599

(22) Filed: Oct. 27, 2021

(30) Foreign Application Priority Data
Oct. 28, 2020 (JP) 2020-180423

(51) Int. Cl. H02K 21/24

(52) U.S. Cl. CPC H02K 21/24

(57) ABSTRACT

In a motor including an armature, and a field system having a plurality of magnetic poles arrayed in second directions orthogonal to first directions via a gap from the armature in the first directions and a frame including a conducting material and holding the plurality of magnetic poles, the frame has a first slit provided along a line of magnetic force generated by the plurality of magnetic poles in a planar pattern as seen from the first direction.

The present application is based on, and claims priority from JP Application Serial Number 2020-180423, filed Oct. 28, 2020, the disclosure of which is hereby incorporated by reference herein in its entirety.

### BACKGROUND

### 1. Technical Field

The present disclosure relates to a motor and a method of manufacturing a field system.

### 2. Related Art

JP-A-2004-72820 discloses a technique of forming a Halbach magnet array by placing a plurality of unmagnetized magnets fixed to an outer circumferential surface of a rotor core in a predetermined space and collectively magnetizing the magnets for manufacturing a rotor of an AC motor.

However, in the technique disclosed in JP-A-2004-72820, a loss of a field for magnetization may increase due to an eddy current generated in the rotor core as a frame for fixing the unmagnetized magnets.

### SUMMARY

An aspect is directed to a motor including an armature, and a field system having a plurality of magnetic poles arrayed in second directions orthogonal to first directions via a gap from the armature in the first directions and a frame including a conducting material and holding the plurality of magnetic poles, wherein the frame has a first slit provided along a line of magnetic force generated by the plurality of magnetic poles in a planar pattern as seen from the first direction.

Another aspect is directed to a method of manufacturing a field system having a plurality of magnetic poles arrayed in second directions orthogonal to first directions via a gap from the armature in the first directions and a frame holding the plurality of magnetic poles, including holding an object to be magnetized to be the plurality of magnetic poles by the frame including a conducting material and having a first slit provided along a line of magnetic force generated by the plurality of magnetic poles in a planar pattern as seen from the first direction, and applying a magnetic field to realize the line of magnetic force to the object to be magnetized held by the frame by a magnetizing device.

### BRIEF DESCRIPTION OF THE DRAWINGS

FIG. 1 is a sectional view for explanation of a motor according to a first embodiment.

FIG. 2 is a plan view for explanation of an armature of the motor.

FIG. 3 is a plan view for explanation of a field system of the motor.

FIG. 4 is a sectional view for explanation of magnetization directions of magnet arrays as seen from line IV-IV in FIG. 3 with respect to each number of poles for a half period.

FIG. 5 is a plan view for explanation of the field system as seen from a first direction.

FIG. 6 is a plan view for explanation of a frame as seen from the first direction.

FIG. 7 is a sectional view as seen from a third direction for explanation of eddy currents in the frame in a manufacturing process of the field system .

FIG. 8 is a plan view corresponding to FIG. 7.

FIG. 9 is a sectional view as seen from the third direction for explanation of other eddy currents in the frame in the manufacturing process of the field system.

FIG. 10 is a plan view corresponding to FIG. 9.

FIG. 11 is a plan view for explanation of a frame in a modified example.

FIG. 12 is a plan view for explanation of first slits in another modified example.

FIG. 13 is a plan view for explanation of first slits in another modified example.

FIG. 14 is a plan view for explanation of first slits in another modified example.

FIG. 15 is a plan view for explanation of first slits in another modified example.

FIG. 16 is a plan view for explanation of first slits in another modified example.

FIG. 17 is a plan view for explanation of a second slit in another modified example.

FIG. 18 is a plan view for explanation of second slits in another modified example.

FIG. 19 is a plan view for explanation of second and third slits in another modified example.

FIG. 20 is a plan view for explanation of second and third slits in another modified example.

FIG. 21 is a plan view for explanation of a frame in another modified example.

FIG. 22 is a plan view for explanation of a frame in another modified example.

FIG. 23 is a plan view for explanation of a frame in a second embodiment.

FIG. 24 is an enlarged sectional view of the frame for explanation of slits as seen from a longitudinal direction.

FIG. 25 is a plan view for explanation of a frame in a third embodiment.

FIG. 26 is a sectional view for explanation of a field system in a fourth embodiment as seen from the third direction.

FIG. 27 is a plan view corresponding to FIG. 26.

FIG. 28 is a sectional view for explanation of a motor according to another embodiment.

### DESCRIPTION OF EXEMPLARY EMBODIMENTS

As below, an embodiment of the present disclosure will be explained with reference to the drawings. The embodiment exemplifies an apparatus and a method for implementing the technical idea of the present disclosure. The technical idea of the present disclosure does not specify materials, shapes, structures, placements, etc. of component elements to the following ones. In the drawings, the same or similar elements respectively have the same or similar signs and the overlapping explanation will be omitted. The drawings are schematic and may include cases where dimensions and relative proportions of dimensions, placements, structures, etc. are different from real ones.

### First Embodiment

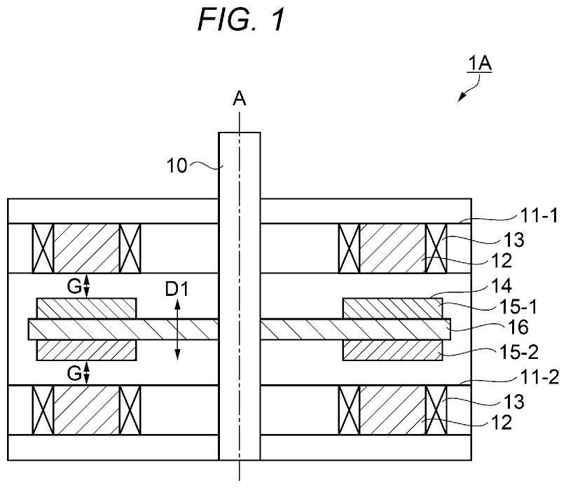

As shown in FIG. 1, a motor 1 according to a first embodiment includes e.g. a shaft 10 coaxially provided with a rotation axis A, a first armature 11-1 and a second armature 11-2 forming a pair, and a field system 14. The rotation axis A is an axis for relative rotation of the first armature 11-1 and the second armature 11-2 to the field system 14. The motor 1 includes e.g. the respective first armature 11-1 and second armature 11-2 as stators and the field system 14 as a rotor. In the example shown in FIG. 1, the motor 1 is an axial gap motor in which gaps G between the respective first armature 11-1 and second armature 11-2 and the field system 14 are defined in first directions D1 as axial directions of the shaft 10.

The first armature 11-1 and the second armature 11-2 have the same structure as each other to have a mirror-image symmetry to each other with respect to a plane orthogonal to the rotation axis A, for example. In the example shown in FIG. 1, the motor 1 includes the two armatures of the first armature 11-1 and the second armature 11-2 placed so that the field system 14 may be located in between, however, only one armature may be provided in the motor 1. Hereinafter, one of the first armature 11-1 and the second armature 11-2 is simply referred to as “armature 11”.

The field system 14 has a first magnet array 15-1 and a second magnet array 15-2 and a frame 16 holding the first magnet array 15-1 and the second magnet array 15-2. The first magnet array 15-1 is placed via the gap G in the first directions D1 between the first armature 11-1 and itself. The second magnet array 15-2 is placed via the gap G in the first directions D1 between the second armature 11-2 and itself. The first magnet array 15-1 and the second magnet array 15-2 have the same structure as each other to have a mirror-image symmetry to each other with respect to a plane orthogonal to the rotation axis A, for example. Hereinafter, one of the first magnet array 15-1 and the second magnet array 15-2 is simply referred to as “magnet array 15”.

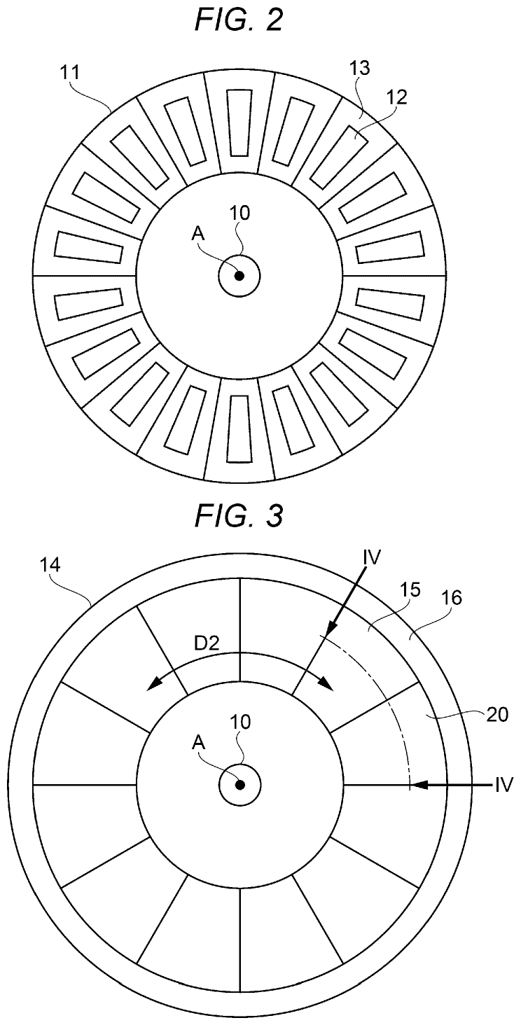

As shown in FIG. 2, the armature 11 substantially has a disk shape. The armature 11 has a plurality of cores 12 and a plurality of coils 13. Each core 12 substantially has a prismatic columnar shape with a height defined in directions along the rotation axis A. Each core 12 may be formed using a plurality of plates of magnetic steel sheets or an amorphous magnetic material stacked in the radial direction of the shaft 10. The core 12 may be a dust core formed by molding of a magnetic material. The plurality of coils 13 are supported by e.g. bobbins and fixed in position relationships with one another. Each coil 13 includes a winding wire wound along the side surface of the core 12.

The number of pairs of cores 12 and coils 13 is e.g. 18. In this case, the plurality of cores 12 and the plurality of coils 13 are annularly arrayed along the circumference around the rotation axis A to have 18 rotational symmetries with respect to the rotation axis A. For example, currents at three phases of U-phase, V-phase, and W-phase circularly flow in the array direction in the plurality of coils 13.

As shown in FIG. 3, the magnet array 15 substantially has an annular shape. The magnet array 15 includes a plurality of magnetic poles 20 arrayed along the circumference around the rotation axis A. That is, the plurality of magnetic poles 20 are arrayed in second directions D2 orthogonal to the first directions D1 via the gap G in the first directions D1 between the armature 11 and themselves. As described above, a tangential line to the circumference around the rotation axis A is orthogonal to the rotation axis A, and the second directions D2 are circumferential directions around the rotation axis A in the first embodiment and array directions of the magnet array 15.

Each of the plurality of magnetic poles 20 is a permanent magnet. The plurality of magnetic poles 20 have magnetization directions periodically different in the second directions D2. The plurality of magnetic poles 20 have a pair of main poles of a first main pole magnetized in the first direction D1 and a second main pole magnetized in a direction opposite to the first direction D1 for one period. The magnet array 15 includes e.g. a plurality of magnetic poles 20 for six periods per rotation.

The frame 16 has e.g. a disk shape. The frame 16 may have a concavo-convex structure that positions the magnet array 15 including two ribs respectively provided along the circumference around the rotation axis A and sandwiching the magnet array 15 in between. The first magnet array 15-1 and the second magnet array 15-2 are fixed on both surfaces using e.g. adhesives, the frame 16 holds the first magnet array 15-1 and the second magnet array 15-2. The frame 16 is formed using a conducting material e.g. a metal or the like. As a material for the base portion of the frame 16, a soft magnetic material such as a magnetic steel sheet or power compacting, a non-magnetic material such as stainless steel, aluminum alloy, or carbon steel, or the like may be employed. As the material for the base portion of the frame 16, an insulating material such as glass, resin, or plastic may be employed.

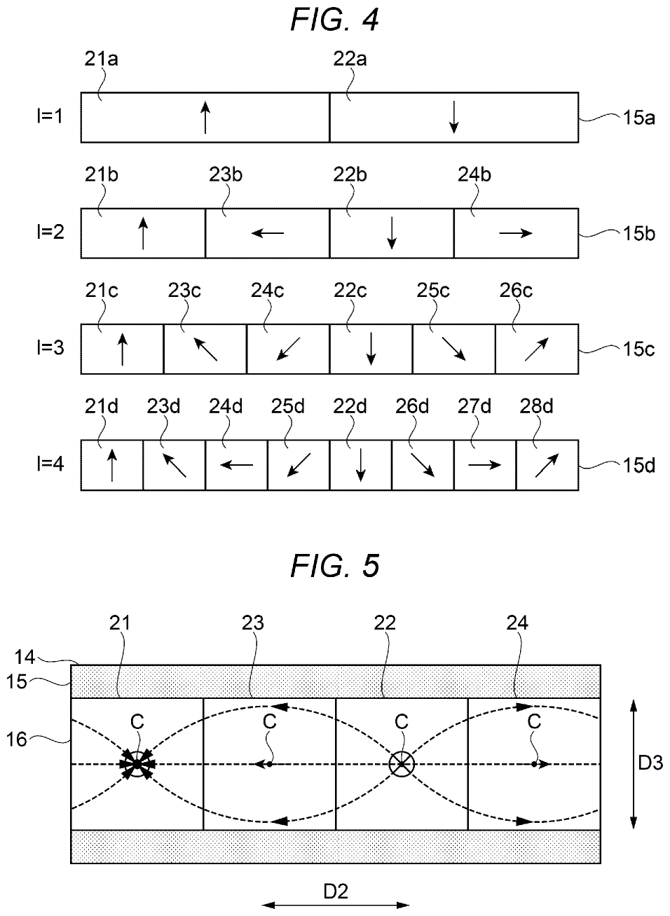

As shown in FIG. 4, when the number of the magnetic poles 20 for a half period in the second directions D2 is I, a magnet array 15a for I=1 has a first main pole 21a and a second main pole 22a as two magnetic poles 20 for one period. That is, each of the plurality of magnetic poles 20 is magnetized in the first direction D1 or the direction opposite to the first direction.

A magnet array 15b for I=2 has a first main pole 21b, a first auxiliary pole 23b, a second main pole 22b, and a second auxiliary pole 24b as four magnetic poles 20 for one period. The respective magnetic poles 20 of the magnet array 15b have magnetization directions different by 90° from the adjacent magnetic poles 20 as seen from the radial direction of the shaft 10. The respective magnetic poles 20 of the magnet array 15b have the magnetization directions changing to rotate by 90° around an axis in the radial direction of the shaft 10 sequentially in the second direction D2.

A magnet array 15c for I=3 has a first main pole 21c, a first auxiliary pole 23c, a second auxiliary pole 24c, a second main pole 22c, a third auxiliary pole 25c, and a fourth auxiliary pole 26c as six magnetic poles 20 for one period. The respective magnetic poles 20 of the magnet array 15c have magnetization directions different by 60° from the adjacent magnetic poles 20 as seen from the radial direction of the shaft 10. The respective magnetic poles 20 of the magnet array 15c have the magnetization directions changing to rotate by 60° around the axis in the radial direction of the shaft 10 sequentially in the array direction.

A magnet array 15d for I=4 has a first main pole 21d, a first auxiliary pole 23d, a second auxiliary pole 24d, a third auxiliary pole 25d, a second main pole 22d, a fourth auxiliary pole 26d, a fifth auxiliary pole 27d, and a sixth auxiliary pole 28d as eight magnetic poles 20 for one period. The respective magnetic poles 20 of the magnet array 15d have magnetization directions different by 45° from the adjacent magnetic poles 20 as seen from the radial direction of the shaft 10. The respective magnetic poles 20 of the magnet array 15d have the magnetization directions changing to rotate by 45° around the axis in the radial direction of the shaft 10 sequentially in the array direction.

As described above, the plurality of magnetic poles 20 of the respective field systems 15b, 15c, 15d form Halbach arrays having the main poles magnetized in the first direction D1 and the auxiliary poles arrayed in the second direction D2 of the main poles. That is, the plurality of magnetic poles 20 of the magnet array 15 for I≥2 form the Halbach array. In the motor 1 having the Halbach array, the armature 11 is placed at the high-field side of the Halbach array to face the Halbach array. In the motor 1 having the Halbach array, magnetic flux density on the surface at the armature 11 side of the Halbach array may be increased and a torque constant may be improved. Particularly, when I≥3, changes in magnetic flux density in the array direction may be made smoother and cogging may be reduced, and the torque constant may be further improved.

As shown in FIG. 5, as below, the field system 14 having the magnet array 15b for I=2 as the magnet array 15 will be exemplarily explained. Note that, for simplification of explanation, the second directions D2 as the circumferential directions in the first embodiment are drawn as linear directions in the drawings of FIG. 5 and the subsequent drawings. The magnet array 15 as the Halbach array has a first main pole 21, a first auxiliary pole 23, a second main pole 22, and a second auxiliary pole 24. For example, as shown by broken lines in FIG. 5, at the frame 16 side (the depth side of paper) of the magnet array 15, lines of magnetic force generated by the magnet array 15 may be schematically represented as lines radially exiting from a center C of the second main pole 22 and entering a center C of the first main pole 21.

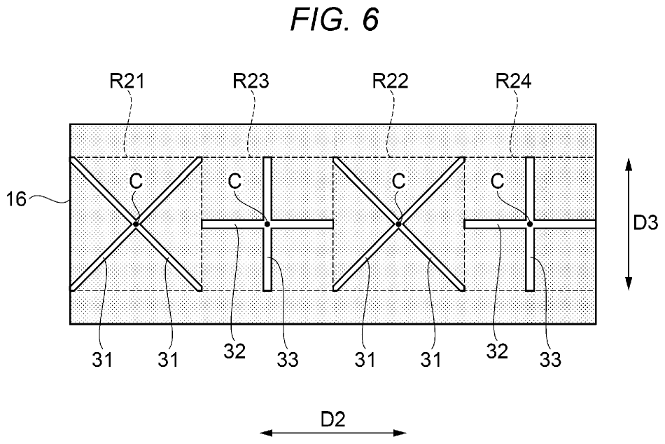

As shown in FIG. 6, the frame 16 has e.g. a plurality of first slits 31 and a plurality of second slits 32 provided along the lines of magnetic force generated by the magnet array 15 in a planar pattern as seen from the first direction D1 and a plurality of third slits 33. The respective slits of the first slits 31, the second slits 32, and the third slits 33 open in the surface of the frame 16 and have depths in the first directions D1. The respective slits may open in both surfaces of the frame 16. That is, the respective slits may penetrate from one surface to the other surface of the frame 16.

The plurality of first slits 31 are provided within an area R21 overlapping with the first main pole 21 of the frame 16 and within an area R22 overlapping with the second main pole 22 of the frame 16 in the planar pattern as seen from the first direction D1. The first slits 31 provided within the area R21 are provided on straight lines passing through the center C of the first main pole 21 in the planar pattern as seen from the first direction D1. The first slits 31 provided within the area R22 are provided on straight lines passing through the center C of the second main pole 22 in the planar pattern as seen from the first direction D1. That is, the respective first slits 31 are provided so that center lines in longitudinal directions may be aligned with the straight lines passing through the center C of the first main pole 21 or the second main pole 22 in the planar pattern as seen from the first direction D1.

For example, the respective first slits 31 are provided so that angles formed between a straight line along the second directions D2 and themselves may substantially be the same in the planar pattern as seen from the first direction D1. In the example shown in FIG. 6, the two first slits 31 are provided to be orthogonal to each other in each of the area R21 and the area R22 in the planar pattern as seen from the first direction D1. The respective first slits 31 are linearly extended to reach boundaries of the area R21 or the area R22 in the planar pattern as seen from the first direction D1.

The two first slits 31 within the area R21 have a line symmetry with respect to a straight line along the third directions D3 orthogonal to the second directions D2 and passing through the center C of the first main pole 21 in the planar pattern as seen from the first direction D1. In other words, the first slits 31 within the area R21 have a mirror-image symmetry with respect to a plane orthogonal to the second directions D2 and passing through the center C of the first main pole 21. Similarly, the two first slits 31 within the area R22 have a line symmetry with respect to a straight line along the third directions D3 and passing through the center C of the second main pole 22 in the planar pattern as seen from the first direction D1. In other words, the first slits 31 within the area R22 have a mirror-image symmetry with respect to a plane orthogonal to the second directions D2 and passing through the center C of the second main pole 22.

The plurality of second slits 32 are provided within an area R23 overlapping with the first auxiliary pole 23 of the frame 16 and within an area R24 overlapping with the second auxiliary pole 24 of the frame 16 in the planar pattern as seen from the first direction D1. The second slit 32 provided within the area R23 is provided to pass through the center C of the first auxiliary pole 23 along the second directions D2 in the planar pattern as seen from the first direction D1. The second slit 32 provided within the area R24 is provided to pass through the center C of the second auxiliary pole 24 along the second directions D2 in the planar pattern as seen from the first direction D1. For example, the respective second slits 32 are linearly extended to reach boundaries of the area R23 or the area R24 in the planar pattern as seen from the first direction D1.

The second slit 32 of the area R23 has a line symmetry with respect to a straight line along the third directions D3 and passing through the center C of the first auxiliary pole 23 in the planar pattern as seen from the first direction D1. In other words, the second slit 32 within the area R23 has a mirror-image symmetry with respect to a plane orthogonal to the second directions D2 and passing through the center C of the first auxiliary pole 23. The second slit 32 of the area R24 has a line symmetry with respect to a straight line along the third directions D3 and passing through the center C of the second auxiliary pole 24 in the planar pattern as seen from the first direction D1. In other words, the second slit 32 within the area R24 has a mirror-image symmetry with respect to a plane orthogonal to the second directions D2 and passing through the center C of the second auxiliary pole 24.

The plurality of third slits 33 are provided within the area R23 and within the area R24 in the planar pattern as seen from the first direction D1. The third slit 33 provided within the area R23 is provided to pass through the center C of the first auxiliary pole 23 along the third directions D3 in the planar pattern as seen from the first direction D1. The third slit 33 provided within the area R24 is provided to pass through the center C of the second auxiliary pole 24 along the third directions D3 in the planar pattern as seen from the first direction D1. For example, the respective third slits 32 are linearly extended to reach boundaries of the area R23 or the area R24 in the planar pattern as seen from the first direction D1.

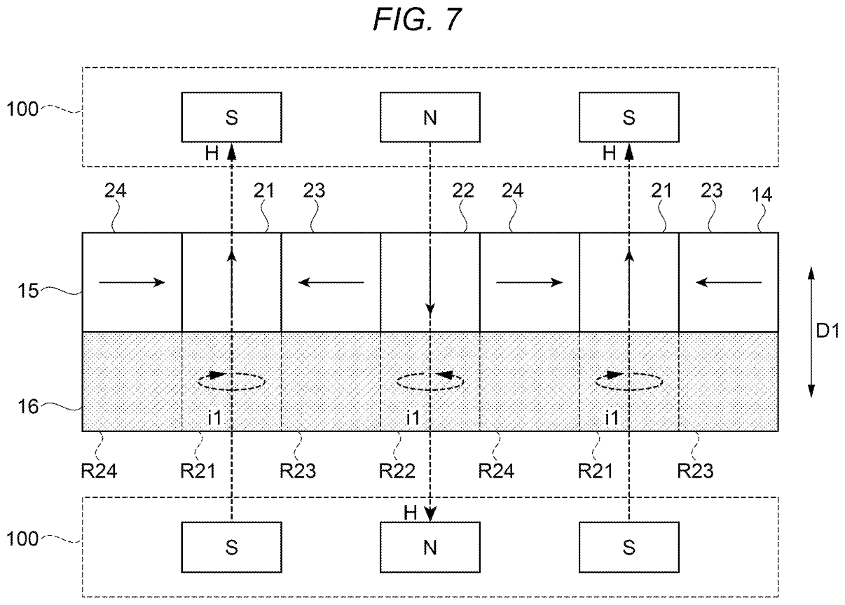

Referring to FIGS. 7 to 10, an example of a method of manufacturing the motor 1 in the first embodiment will be explained. First, for example, the plurality of first slits 31, the plurality of second slits 32, and the plurality of third slits 33 as shown in FIG. 6 are provided in the base portion of the conducting material, and thereby, the frame 16 is formed. That is, in the planar pattern as seen from the first direction D1, the plurality of first slits 31, the plurality of second slits 32, and the plurality of third slits 33 are provided along the lines of magnetic force generated by the plurality of magnetic poles 20 in the base portion to be the frame 16.

Then, an object to be magnetized to be the plurality of magnetic poles 20 each having the first main pole 21, the first auxiliary pole 23, the second main pole 22, and the second auxiliary pole 24 is fixed to the frame 16 via e.g. an adhesive, and thereby, the object to be magnetized is held by the frame 16. The object to be magnetized is an array of a plurality of magnetic materials to be the plurality of magnetic poles 20 magnetized by a magnetizing device 100. Accordingly, for magnetization by the magnetizing device 100, positions of the object to be magnetized and the frame 16 are fixed relative to the magnetizing device 100. In place of the adhesive, e.g. a fixing member of a resin material mixed with heat-conductive filler formed to fix the object to be magnetized to the frame 16 by molding or the like may be employed.

A pulsed magnetic field H realizing e.g. the lines of magnetic force shown in FIG. 5 is applied to the object to be magnetized held by the frame 16 by the magnetizing device 100. Thereby, the object to be magnetized changes to the magnet array 15 including the plurality of magnetic poles 20. That is, the first main poles 21, the first auxiliary poles 23, the second main poles 22, and the second auxiliary poles 24 are magnetized at the same time.

The respective plurality of first slits 31, plurality of second slits 32, and plurality of third slits 33 are provided along the lines of magnetic force generated by the magnetized magnet array 15 in the planar pattern as seen from the first direction D1. Here, the lines of magnetic force generated by the magnet array 15 correspond to the lines of magnetic force showing the magnetic field H generated by the magnetizing device 100.

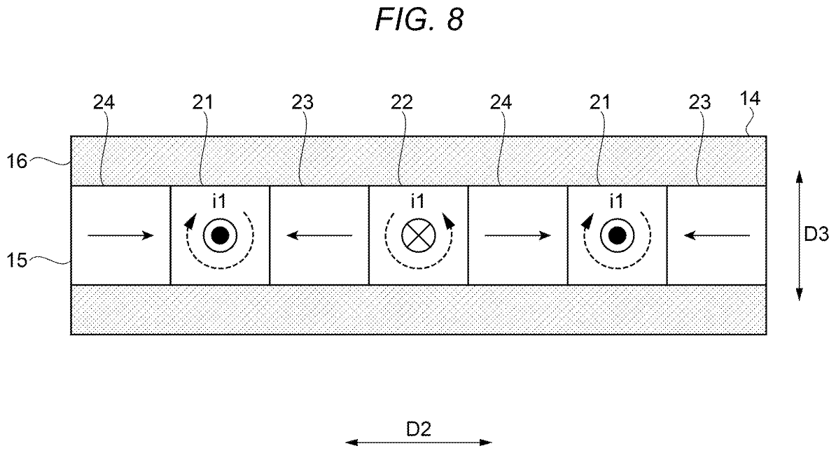

As shown in FIGS. 7 and 8, of the lines of magnetic force showing the magnetic field H by the magnetizing device 100, the lines of magnetic force along the first directions D1 pass through the area R21 and the area R22 of the frame 16 in addition to the first main pole 21 and the second main pole 22. Accordingly, in the area R21 and the area R22 of the frame 16, eddy currents i1 are generated along a plane orthogonal to the first directions D1 in directions to prevent changes in magnetic field H by the magnetizing device 100.

The first slit 31 blocks the pathway of the eddy current i1 that may be generated in the frame 16 without the first slit 31, and thereby, the pathway of the eddy current i1 in the frame 16 is shortened. Therefore, the frame 16 has the first slit 31, and thereby, a loss of magnetic energy of the magnetic field H due to the eddy current i1 may be reduced. When the frame 16 is formed using a non-magnetic material such as stainless steel, the mechanical strength of the frame 16 may be improved and the production cost in view of workability etc. may be reduced. On the other hand, when the frame 16 is formed using a soft magnetic material, the lines of magnetic force by the magnetic field H are easily passed, and magnetization efficiency may be improved. Accordingly, even when a plurality of the magnet arrays 15 are held on both sides of the frame 16 like the first magnet array 15-1 and the second magnet array 15-2, the plurality of magnet arrays 15 can be magnetized at the same time.

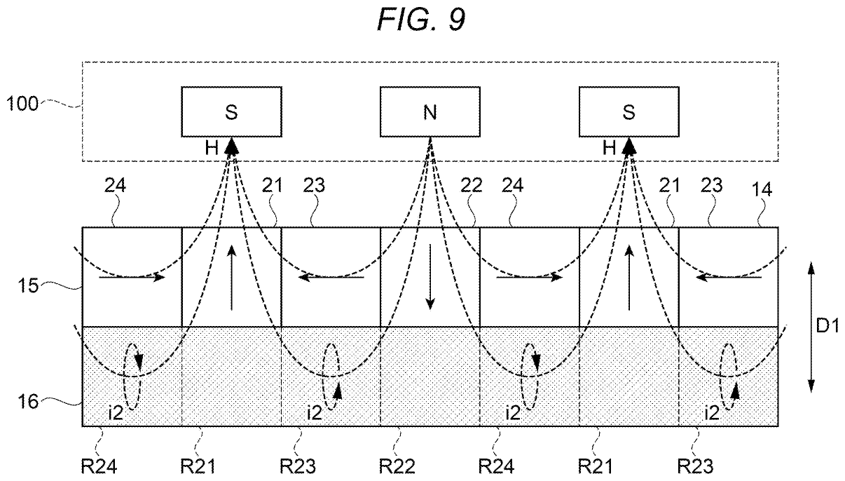

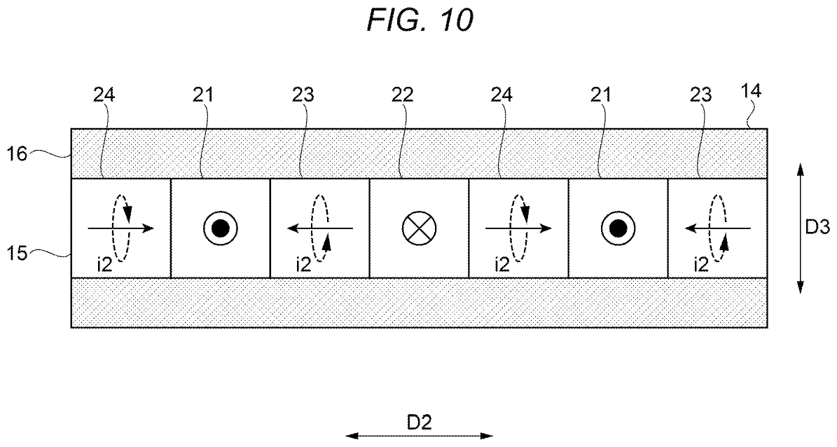

As shown in FIGS. 9 and 10, of the lines of magnetic force showing the magnetic field H, the lines of magnetic force along the second directions D2 pass through the area R23 and the area R24 of the frame 16 in addition to the first auxiliary pole 23 and the second auxiliary pole 24. Accordingly, in the area R23 and the area R24 of the frame 16, eddy currents i2 are generated along a plane orthogonal to the second directions D2 in directions to prevent changes in magnetic field H by the magnetizing device 100.

The second slit 32 blocks the pathway of the eddy current i2 that may be generated in the frame 16 without the second slit 32, and thereby, the pathway of the eddy current i2 in the frame 16 is shortened. Therefore, the frame 16 has the second slit 32, and thereby, a loss of magnetic energy of the magnetic field H due to the eddy current i2 may be reduced.

Though not shown in the drawings, the eddy current i1 (see FIGS. 7 and 8) generated along the plane orthogonal to the first directions D1 may be generated in the area R23 and the area R24. The second slit 32 and the third slit 33 block the pathway of the eddy current i1 that may be generated in the frame 16 without the second slit 32 and the third slit 33, and thereby, the pathway of the eddy current i1 in the frame 16 is shortened. Therefore, the frame 16 has at least one of the second slit 32 and the third slit 33, and thereby, the loss of magnetic energy of the magnetic field H due to the eddy current i1 may be further reduced.

As described above, the frame 16 has at least one type of the first slit 31, the second slit 32, and the third slit 33, and thereby, the loss of the magnetic field H applied to the object to be magnetized may be reduced. Therefore, intensity of the magnetic field H used for changing the object to be magnetized into the plurality of magnetic poles 20 may be improved and the magnetization efficiency may be improved. That is, the magnetic property realized by the magnet array 15 may be improved relative to the constant magnetic energy output by the magnetizing device 100.

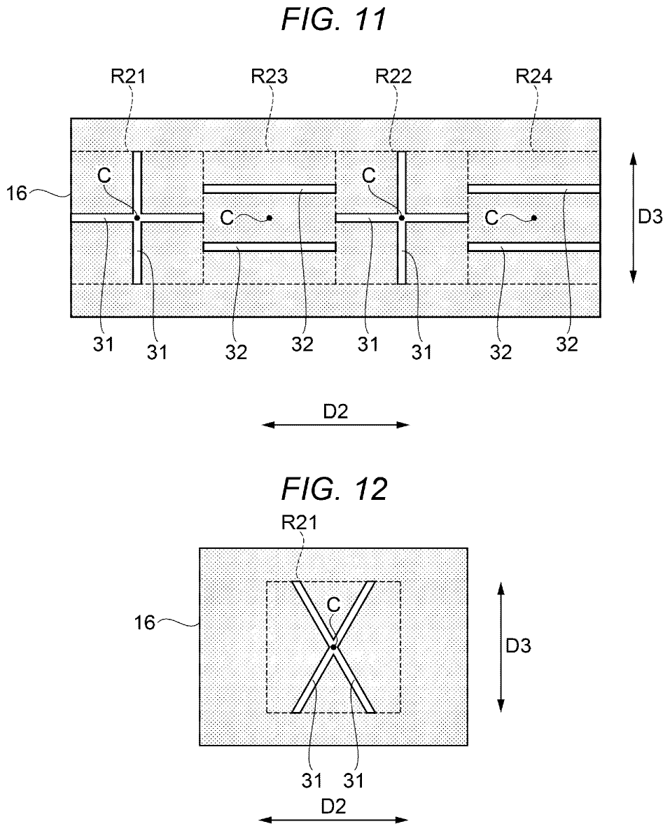

As below, referring to FIGS. 11 to 22, the respective frames 16 in various modified examples of the first embodiment will be explained. The configurations, functions, and effects not to be described in the following modified examples are the same as those of the above described first embodiment and omitted to avoid overlap.

As shown in FIG. 11, the first slits 31 may be provided on straight lines passing through the respective centers C of the first main pole 21 and the second main pole 22 in the planar pattern as seen from the first direction D1. That is, the first slits 31 may be provided along the second directions D2 like the second slits 32 or provided along the third directions D3 like the third slits 33. The first slits 31 in the respective area R21 and area R22 are provided to be orthogonal to each other.

The number of second slits 32 in the respective area R23 and area R24 may be two. In the example shown in FIG. 11, the two second slits 32 in the respective area R23 and area R24 are provided along the second directions D2 to have a line symmetry with respect to the straight lines passing through the centers C. Further, the third slits may be omitted.

As shown in FIG. 12, the first slits 31 in the area R21 may be provided to form arbitrary angles relative to the second directions D2 in the planar pattern as seen from the first direction D1. In each of FIGS. 12 to 16, only the area R21 is selectively shown and explained, however, the same applies to the area R22.

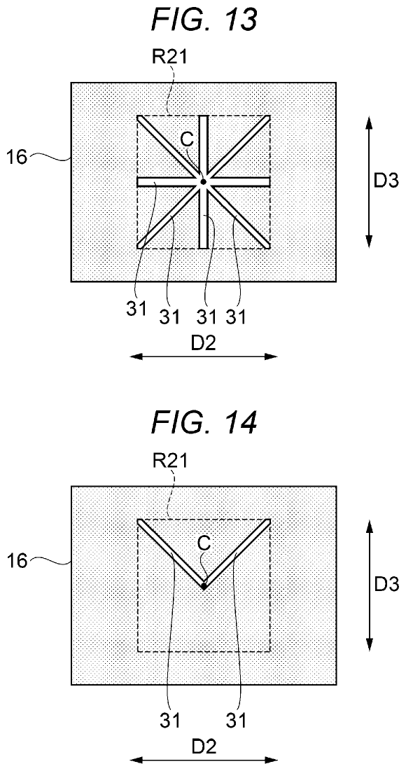

As shown in FIG. 13, the number of first slits 31 in the area R21 may be three or more. Note that, in the example shown in FIG. 13, the four first slits 31 in the area R21 have a pattern in which the first slits 31 in the area R21 shown in FIG. 6 and the first slits 31 in in the area R21 shown in FIG. 11 overlap.

As shown in FIG. 14, the first slits 31 in the area R21 may be provided not to reach the boundaries of the area R21 in the planar pattern as seen from the first direction D1. In the example shown in FIG. 14, the two first slits 31 respectively extend from the center C to the boundaries of the area R21 in single directions in the planar pattern as seen from the first direction D1.

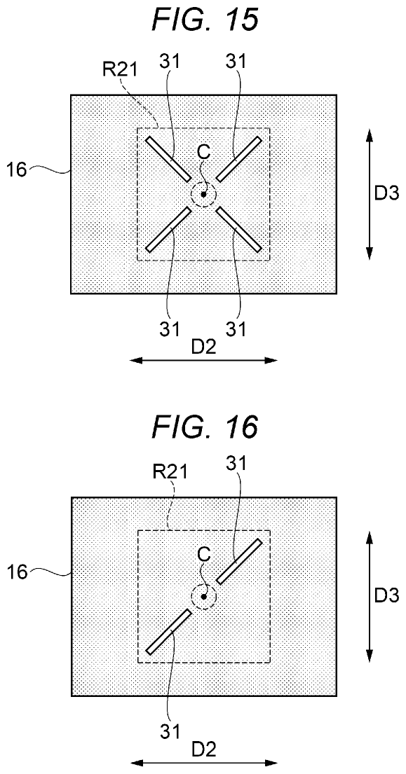

As shown in FIG. 15, the first slits 31 in the area R21 may be provided in an area except the center C in the planar pattern as seen from the first direction D1. In the example shown in FIG. 15, the four first slits 31 are provided on straight lines passing through the center C in an area except the area at a predetermined distance from the center C within the area R21. Thereby, when the base portion of the frame 16 is formed using a soft magnetic material, the magnetic field H for magnetization is easily passed through the center of the area R21 and, as a result, the magnetization efficiency of the respective main poles may be improved. The respective first slits 31 are provided not to reach the boundaries of the area R21, however, may be provided to reach the boundaries of the area R21.

As shown in FIG. 16, the first slits 31 in the area R21 may be provided not to have a line symmetry with respect to a straight line passing along the third directions D3 through the center C. Note that, in the example shown in FIG. 16, the two first slits 31 in the area R21 are placed to have two rotational symmetries with respect to the center C.

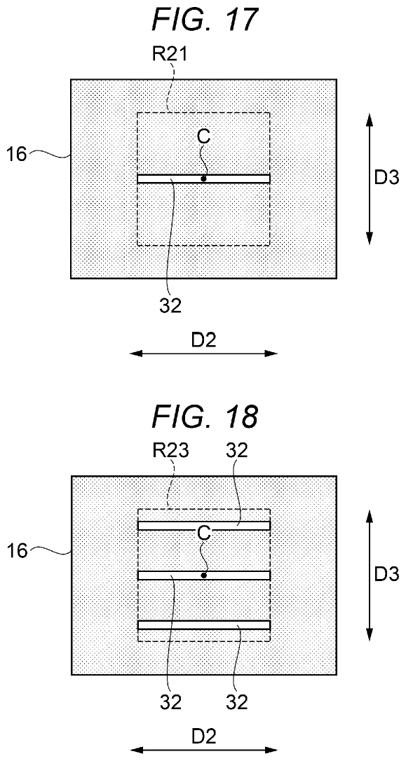

As shown in FIG. 17, the number of second slits 32 in the area R23 may be one. As shown in FIG. 18, the number of second slits 32 in the area R23 may be three or more. Further, the second slits 32 may be provided not to reach the boundaries of the area R23. In each of FIGS. 17 to 20, only the area R23 is selectively shown and explained, however, the same applies to the area R24.

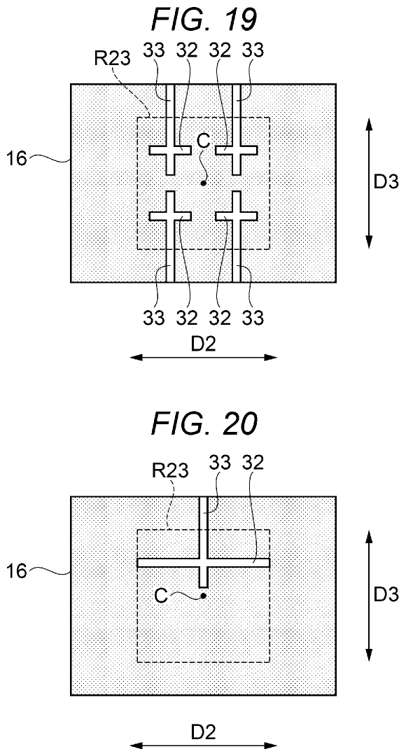

As shown in FIG. 19, the plurality of second slits 32 in the area R23 may be provided on straight lines along the second directions D2 in the planar pattern as seen from the first direction D1. In the example shown in FIG. 19, the two second slits 32 are provided apart from each other on the straight line along the second directions D2. In the area R23, the four second slits 32 are provided to have a line symmetry with respect to each of a straight line along the second directions D2 and a straight line along the third directions D3 passing through the center C.

Further, the plurality of third slits 33 in the area R23 may be provided on straight lines along the third directions D3 in the planar pattern as seen from the first direction D1. That is, in the example shown in FIG. 19, the two third slits 33 are provided apart from each other on a straight line along the third directions D3. The respective third slits 33 are provided to be orthogonal to the second slits 32. In the area R23, the four third slits 33 are provided to have a line symmetry with respect to each of a straight line along the second directions D2 and a straight line along the third directions D3 passing through the center C. The respective third slits 33 are provided to reach end surfaces in the third directions D3 of the frame 16. Thereby, the loss of the magnetic energy of the magnetic field H due to the eddy current i1 may be further reduced.

As shown in FIG. 20, in the area R23, only one third slit 33 may be provided to reach the end surface in the third directions D3 of the frame 16. Similarly, in the area R23, only one second slit 32 may be provided to be orthogonal to the third slits 33.

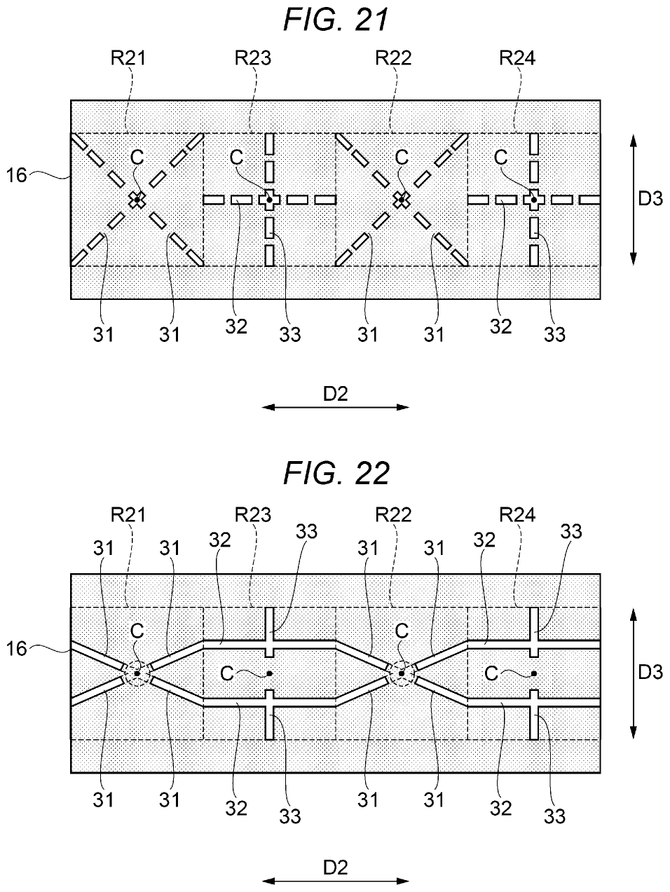

As shown in FIG. 21, the frame 16 may have a plurality of first slits 31a, a plurality of second slits 32a, and a plurality of third slits 33a respectively having intermittent patterns in place of the plurality of first slits 31, the plurality of second slits 32, and the plurality of third slits 33. The respective first slits 31a, second slits 32a, and third slits 33a may extend in broken line forms in the same directions as those of the first slits 31, the second slits 32, or the third slits 33.

As shown in FIG. 22, the respective plurality of second slits 32 may be provided to be continuous to the first slits 31. That is, the respective second slits 32 are continuous to the first slits 31 at boundaries of the area R23 or the area R24. Thereby, when the first slits 31 and the second slits 32 are continuously processed, the manufacturing process may be simplified. Further, in the example shown in FIG. 22, the first slits 31, the second slits 32, and the third slits 33 are provided in areas except the respective centers C of the areas R21 to R24. Accordingly, when the base portion of the frame 16 is formed using a soft magnetic material, the magnetic field H for magnetization is easily passed through the center of the area R21 and, as a result, the magnetization efficiency of the respective main poles may be improved.

The armature 11 and the field system 14 relatively move in the second directions D2 as the array directions of the magnet array 15. For example, at least ones of the first slits 31, the second slits 32, and the third slits 33 have line a symmetry with respect to straight lines along the third directions D3 in the planar pattern as seen from the first direction D1. Therefore, the characteristics in the motion in both directions may have a symmetry and harmonic components in the motion may be reduced.

The respective slits of the first slits 31, the second slits 32, and the third slits 33 open in the surface of the frame 16. The eddy currents due to the magnetic field H of the magnetizing device 100 concentrate on the vicinity of the surface of the frame 16 by the skin effect, and therefore, the pathways of the eddy currents may be efficiently shortened by the respective slits. Furthermore, when the respective slits penetrate from one surface to the other surface of the frame 16, the pathways of the eddy currents may be shortened more efficiently.

### Second Embodiment

As shown in FIG. 23, a frame 16 in a motor according to a second embodiment is different from that of the first embodiment in that the frame 16 further has members filled within the respective slits. The configurations, functions, and effects not to be described in the second embodiment are the same as those of the above described first embodiment including the respective modified examples and omitted to avoid overlap.

Specifically, the frame 16 has first yoke portions 41 placed within the respective first slits 31, second yoke portions 42 placed within the respective second slits 32, and third yoke portions 43 placed within the respective third slits 33. Hereinafter, when the first yoke portions 41, the second yoke portions 42, and the third yoke portions 43 are not distinguished, the yoke portions are simply referred to as “yoke portions 40”. Similarly, when the first slits 31, the second slits 32, and the third slits 33 are not distinguished, the slits are simply referred to as “slits 30”.

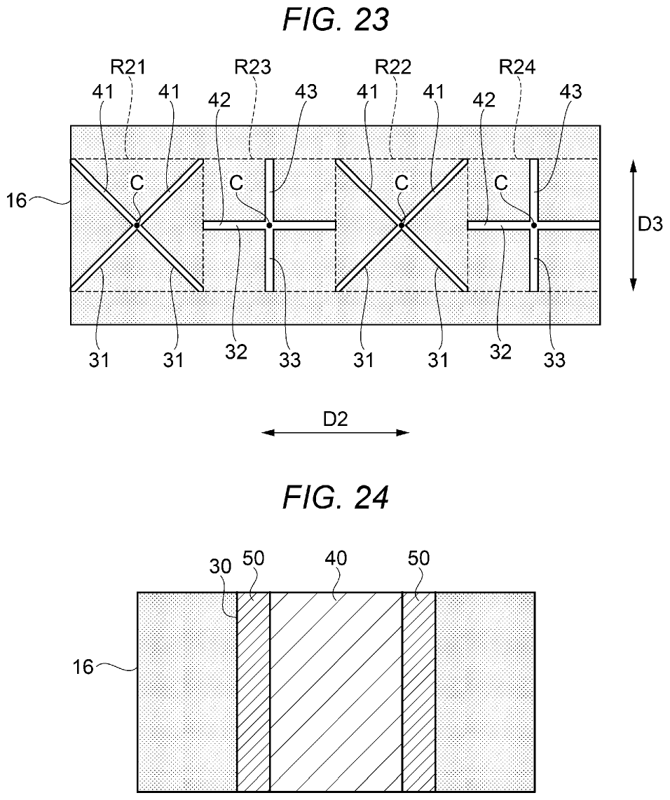

As shown in FIG. 24, the yoke portion 40 is formed using a soft magnetic material filled within the slit 30 via insulating films 50 provided on the inner walls of the slit 30. The insulating films 50 can be formed from various insulating materials used in a semiconductor manufacturing process e.g. silicon oxide films, silicon nitride films, or the like. The yoke portion 40 may be selectively placed in at least one of the first slit 31, the second slit 32, and the third slit 33. The frame 16 has the yoke portions 40, and thereby, the pathways of the eddy currents may be shortened, the magnetic field H for magnetization is easily passed through the slits 30, and magnetization efficiency of the magnet array 15 may be improved.

Further, for example, as shown by broken lines in FIG. 15, the frame 16 may have circular columnar yoke portions 40 in areas at a predetermined distance from the center within the area R21 in the planar pattern as seen from the first direction D1. The same applies to the area R22. Thereby, the magnetic field H for magnetization is easily passed through the yoke portions 40 and, as a result, the magnetization efficiency of the respective main poles may be improved.

### Third Embodiment

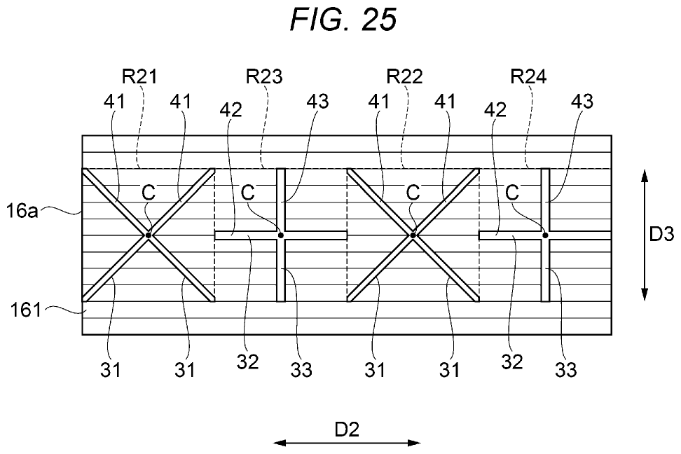

As shown in FIG. 25, a motor according to a third embodiment may have a frame 16a including a plurality of steel plates 161 stacked in the third directions D3 in place of the frame 16. The configurations, functions, and effects not to be described in the third embodiment are the same as those of the above described first and second embodiments and omitted to avoid overlap.

The plurality of steel plates 161 are magnetic steel sheets of a soft magnetic material. Insulating materials are placed between the plurality of steel plates 161, and thereby, the plurality of steel plates 161 are insulated from each other. As described above, the plurality of steel plates 161 already have the functions of the second slits 32. Accordingly, the second slits 32 are shown in the example shown in FIG. 25, but the second slits 32 may be omitted.

### Fourth Embodiment

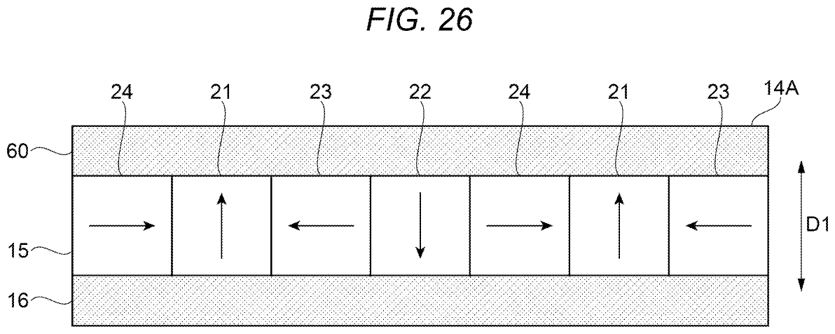

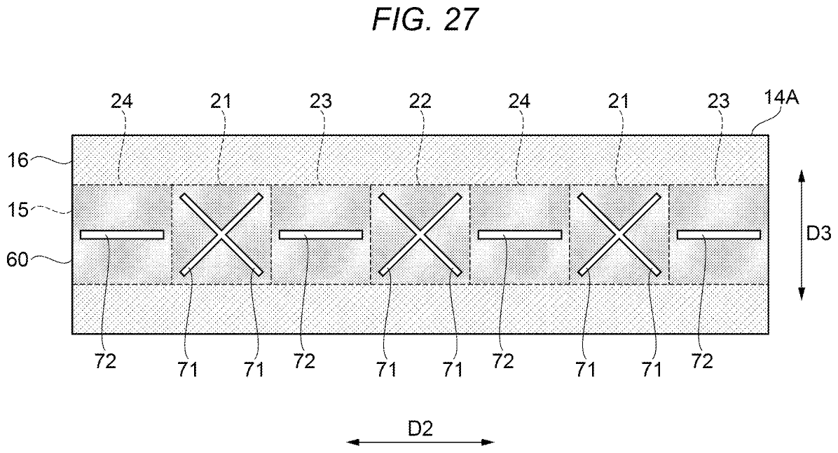

As shown in FIGS. 26 and 27, a motor according to a fourth embodiment is different from the first to third embodiments in that a field system 14A further having a slot cover 60 that covers the magnet array 15 is provided. As the material for the slot cover 60, a soft magnetic material such as a magnetic steel sheet may be employed. The configurations, functions, and effects not to be described in the fourth embodiment are the same as those of the above described first to third embodiments and omitted to avoid overlap.

The slot cover 60 has a plurality of first cover slits 71 and a plurality of second cover slits 72. The first cover slits 71 and the second cover slits 72 are provided along lines of magnetic force generated by the magnet array 15 in the planar pattern as seen from the first direction D1 like the first slits 31 and the second slits 32. Specifically, the first cover slits 71 may have the same various shapes as the above described first slits 31 in the planar pattern as seen from the first direction D1. Similarly, the second cover slits 72 may have the same various shapes as the above described second slits 32 in the planar pattern as seen from the first direction D1.

Further, the slot cover 60 may have third cover slits (not shown) provided along the third directions D3 like the third slits 33 in the planar pattern as seen from the first direction D1.

### Other Embodiments

As above, the embodiments are explained, however, the present disclosure is not limited to these disclosures. The configurations of the respective parts may be replaced by arbitrary configurations having the same functions, and arbitrary configurations in the respective embodiments may be omitted or added within the technical scope of the present disclosure. From these disclosures, various alternative embodiments will be clear to those skilled in the art.

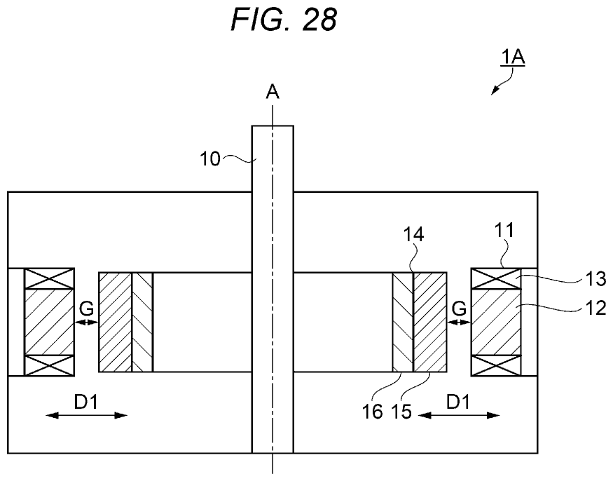

In the above described first to fourth embodiments, the axial gap motor 1 is explained, however, the type of the motor is not limited to the axial gap type. For example, as shown in FIG. 28, a motor 1A according to another embodiment is a radial gap motor in which the gap G between the armature 11 and the field system 14 is defined in the radial direction of the shaft 10 coaxially provided with the rotation axis A. In this case, the first directions D1 are the radial directions of the shaft 10, the second directions D2 are the circumferential directions around the rotation axis A, and the third directions D3 are the directions parallel to the rotation axis A, i.e., the axial directions of the shaft 10. The motor 1A includes e.g. the armature 11 as a stator and the field system 14 as a movable member.

Or, obviously, the motor 1 may be a linear motor. The respective motors may function as power generators. When forming a power generator or a motor generator, the field system 14 in the respective embodiments may obviously reduce the loss of the magnetic field for magnetization of the magnet array 15.

Further, in the respective first, third, and fourth embodiments, the respective slits functioning as air gaps may improve the mechanical strength as the ratio occupied in the base portion of the frame 16 decreases. Furthermore, the respective slits may be filled with insulating materials such as glass or resin materials. Thereby, the mechanical strength of the frame 16 may be improved. The motor 1 may include the armature 11 as a movable member and the field system 14 as a stator.

In addition, the present disclosure obviously includes various embodiments not described as above such as configurations formed by mutual application of the arbitrary configurations described in the first to fourth embodiments including the above described respective modified examples. The technical scope of the present disclosure is defined only by the matters used to specify the invention according to the appended claims appropriate from the above explanation.

What is claimed is:

1. A motor comprising:
an armature; and
a field system having a plurality of magnetic poles arrayed in second directions orthogonal to first directions via a gap from the armature in the first directions and a frame including a conducting material and holding the plurality of magnetic poles, wherein
the frame has a first slit provided along a line of magnetic force generated by the plurality of magnetic poles in a planar pattern as seen from the first direction.

2. The motor according to claim 1, wherein
the first slit opens in a surface of the frame and has a depth in the first directions.

3. The motor according to claim 1, wherein
the first slit has a line symmetry with respect to a straight line orthogonal to the second directions in the planar pattern.

4. The motor according to claim 1, wherein
the plurality of magnetic poles form a Halbach array having a main pole magnetized in the first directions and an auxiliary pole arrayed in the second directions of the main pole.

5. The motor according to claim 4, wherein
the first slit is provided on a straight line passing through a center of the main pole within an area overlapping with the main pole of the frame in the planar pattern.

6. The motor according to claim 5, wherein
the first slit is provided in an area except the center of the main pole in the planar pattern.

7. The motor according to claim 4, wherein
the frame has a second slit provided along the second directions within an area overlapping with the auxiliary pole of the frame in the planar pattern.

8. The motor according to claim 7, wherein
the second slit is continuously provided to the first slit.

9. The motor according to claim 4, wherein
the frame further has a third slit provided along third directions orthogonal to the second directions within an area overlapping with the auxiliary pole of the frame in the planar pattern.

10. The motor according to claim 9, wherein
the third slit reaches an end surface in the third direction of the frame.

11. The motor according to claim 1, further comprising a shaft coaxially provided with a relative rotation axis of the armature and the field system.

12. The motor according to claim 11, wherein
the first directions are axial directions of the shaft, and
the second directions are circumferential directions around the rotation axis.

13. The motor according to claim 11, wherein
the first directions are radial directions of the shaft, and
the second directions are circumferential directions around the rotation axis.

14. The motor according to claim 1, wherein
the frame includes a non-magnetic material.

15. The motor according to claim 1, wherein
the frame includes a soft magnetic material.

16. The motor according to claim 1, wherein
the frame has a yoke portion of a soft magnetic material filled within the first slit via an insulating film provided on an inner wall of the first slit.

17. The motor according to claim 1, wherein
the armature is provided as a stator and the field system is provided as a movable member.

18. A method of manufacturing a field system having a plurality of magnetic poles arrayed in second directions orthogonal to first directions via a gap from an armature in the first directions and a frame holding the plurality of magnetic poles, comprising:
holding an object to be magnetized to be the plurality of magnetic poles by the frame including a conducting material and having a first slit provided along a line of magnetic force generated by the plurality of magnetic poles in a planar pattern as seen from the first direction; and
applying a magnetic field to realize the line of magnetic force to the object to be magnetized held by the frame by a magnetizing device.
